(19) United States
(12) Patent Application Publication
(10) Pub. No.: US 2026/0369136 A1
(43) Pub. Date: Nov. 19, 2026

(54) Gaming System And Method

(71) Applicant: CPCM AMUSEMENTS PTE. LTD., Singapore (SG)

(72) Inventor: JI WEI LAO, Singapore (SG)

(21) Appl. No.: 19/677,095

(22) Filed: May 14, 2026

(30) Foreign Application Priority Data
May 15, 2025 (SG) 10202501248X

(51) Int. Cl. G07F 17/32

(52) U.S. Cl. CPC G07F 17/3297; G07F 17/3216

(57) ABSTRACT

Disclosed herein is a gaming system comprising a plurality of targets configured for being presented to a user for the launch of at least one object thereto by the user, each of the plurality of targets having a sensor for sensing interaction of the at least one object therewith, a controller wherewith the plurality of targets are in signal communication, each of the plurality of targets having an identifier and a response associated with the identifier, and a display in signal communication with the controller and for displaying at least one of generated graphics and video clip associated with the response associated with the identifier of the one of the plurality of targets the object launched by the user has interacted with.

### CROSS REFERENCE TO RELATED APPLICATION

The present application claims the benefit of the Singapore Patent Application No. 10202501248X filed on May 15, 2025. The entire content of the application is incorporated herein by reference for all purposes.

### TECHNICAL FIELD

This invention relates generally to a gaming system and a method for utilising the gaming system.

### BACKGROUND

Carnival games have been a popular form of entertainment for many years, attracting participants of all ages with the promise of fun, challenge, and rewards. Traditionally, these games involve simple, repetitive actions, such as throwing a ball or aiming at a target, which can sometimes become monotonous and predictable. While the excitement of winning a prize can be an incentive for players, the lack of variety in game responses often leads to diminished engagement over time. The traditional carnival game format typically relies on manual operation or basic visual and auditory cues, such as a bell ringing or a light flashing, which do little to enhance the overall player experience.

A primary deficiency of existing carnival gaming systems is their limited capability to dynamically respond to varying levels of player achievement. For example, many traditional games offer the same generic response, such as a flashing light or a single sound effect, regardless of whether the player has made a small or significant achievement. This one-size-fits-all approach does not account for different levels of difficulty within the game, nor does it provide a tiered system of recognition or reward. As a result, players may not feel adequately recognized for their performance, especially when they accomplish a more challenging task within the game.

Additionally, conventional carnival games generally lack customization options for the game operator or the carnival organizer. Most games are built with fixed responses that are difficult or impossible to modify, preventing operators from tailoring the experience to suit different events, audiences, or themes. This lack of flexibility can limit the game’s appeal, particularly in settings where varied or evolving themes are desired to attract and retain participants.

Another issue with current carnival games is that they often do not capitalize on the opportunity to create an immersive, multi-sensory experience. Research has shown that multi-sensory experiences, which engage multiple senses simultaneously, can lead to higher levels of enjoyment and longer-lasting memories. However, most carnival games are limited to basic visual effects, such as lights, and simple audio responses, like buzzers or bells. These limited responses fail to fully engage the player’s senses, reducing the overall impact and memorability of the game.

Furthermore, traditional carnival games typically lack interactivity and do not provide feedback that is sufficiently engaging or entertaining. Once a player has achieved a particular result, such as hitting a target or scoring a certain number of points, there is often little in the way of follow-up interaction or acknowledgment beyond the initial reward. Without varied and engaging responses, players may quickly lose interest, which can reduce the time they spend at the game and, ultimately, the revenue generated by the game operator.

Finally, many existing carnival games are not equipped with technology that enables real-time adaptation to player achievements. For instance, a player might receive the same response, such as a light flash, for a low-value achievement as they would for a high-value achievement. This lack of adaptive response diminishes the incentive to aim for higher achievements, as the rewards do not scale with the level of difficulty.

Given these deficiencies, there exists a need for an improved carnival gaming system that provides diverse and dynamic responses to player achievements. Such a system should be capable of distinguishing between different levels of success and should offer a range of visual and audio responses that reflect the significance of each achievement. Additionally, the system should be adaptable and customizable, allowing operators to modify the responses and themes to create a more engaging, immersive, and memorable experience for players. The present invention addresses these needs by introducing a carnival gaming system that enhances player engagement through multi-sensory feedback and interactive responses tailored to various levels of player achievements.

### SUMMARY

In accordance with a first aspect of the invention, there is disclosed a gaming system comprising a plurality of targets configured for being presented to a user for the launch of at least one object thereto by the user, each of the plurality of targets having a sensor for sensing interaction of the at least one object therewith, a controller wherewith the plurality of targets are in signal communication, each of the plurality of targets having an identifier and a response associated with the identifier, and a display in signal communication with the controller and for displaying at least one of generated graphics and video clip associated with the response associated with the identifier of the one of the plurality of targets the object launched by the user has interacted with.

In accordance with a second aspect of the invention, there is disclosed a gaming method comprising presenting a plurality of targets to a user for the launch of at least one object thereto by the user, the plurality of targets are in signal communication with a controller, each of the plurality of targets having a sensor, an identifier and a response associated with the identifier, sensing interaction of the at least one object with one of the plurality of targets, and displaying on a display at least one of generated graphics and video clip associated with the response associated with the identifier of the one of the plurality of targets the object launched by the user has interacted with, the display in signal communication with the controller. The display further for displaying at least one of gaming instructions, type of prizes available, type of prize won, achievement and messages.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings.

FIG. 1 shows an exemplary front elevation of a gaming system in accordance with an aspect of the invention;

FIG. 2 shows an exemplary system diagram of the gaming system of FIG. 1;

FIG. 3 shows an exemplary process flow diagram of a gaming method utilized by the gaming system of FIG. 2;

FIG. 4 shows a first exemplary corner elevation of the gaming system of FIG. 1;

FIG. 5 shows a second exemplary corner elevation of the gaming system of FIG. 1;

FIG. 6 shows an exemplary rear-corner perspective view of the gaming system of FIG. 1;

FIG. 7 shows a sectional plan view of an exemplary partial configuration of the gaming system of FIG. 1;

FIG. 8 shows a third exemplary corner elevation of the gaming system of FIG. 1 with a target module;

FIG. 9 shows a fourth exemplary corner sectional elevation of the gaming system of FIG. 1 with a target module;

FIG. 10 shows a partial front view of a target of the gaming system of FIG. 1 with the target defining a surface with a sensor and an object interacting with the target;

FIG. 11 shows a partial front view of a target of the gaming system of FIG. 1 with the target defining an aperture with a sensor and a protrusion in an extended position to impede passage of an object through the aperture;

FIG. 12 shows a partial front view of the target of FIG. 11 with the protrusion in a retracted position to enable passage of the object through the aperture;

FIG. 13 shows a perspective view of a target module of the gaming system of FIG. 1 with a plurality of openings configured for an exemplary goblet toss game; and

FIG. 14 shows a perspective view of a target module of the gaming system of FIG. 1 with a plurality of openings and a launch apparatus configured for an exemplary street nineballs game.

### DETAILED DESCRIPTION

Embodiments described below in context of the apparatus are analogously valid for the respective methods, and vice versa. Furthermore, it will be understood that the embodiments described below may be combined, for example, a part of one embodiment may be combined with a part of another embodiment.

Unless the context requires otherwise, the terms “comprise”, “comprises”, “comprising”, and grammatical variants thereof may be used interchangeably with the terms “include”, “includes”, “including”, “have”, “has”, “having”, and grammatical variants thereof.

Unless the context requires otherwise, the term “means” may be used interchangeably with terms such as “unit”, “device”, “mechanism”, “assembly”, “component”, “structure”, “sub-assembly”, or “combination thereof”. Accordingly, for example, a “wired and wireless signaling means” may be understood as referring to any suitable wired and wireless signaling unit, device, mechanism, assembly, component, structure, sub-assembly, or combination thereof. Similarly, a “lighting means” may be understood as referring to any suitable lighting unit, lighting or illumination device, mechanism, assembly, component, structure, sub-assembly, light source, or combination thereof.

Unless the context requires otherwise, expressions such as “for”, “configured for”, “adapted for”, or similar expressions may be used interchangeably with expressions such as “to”, “that”, “configured to”, “adapted to”, “configured such that”. Accordingly, for example, a component described as being “configured for” performing an operation may be understood as being configured to perform the operation.

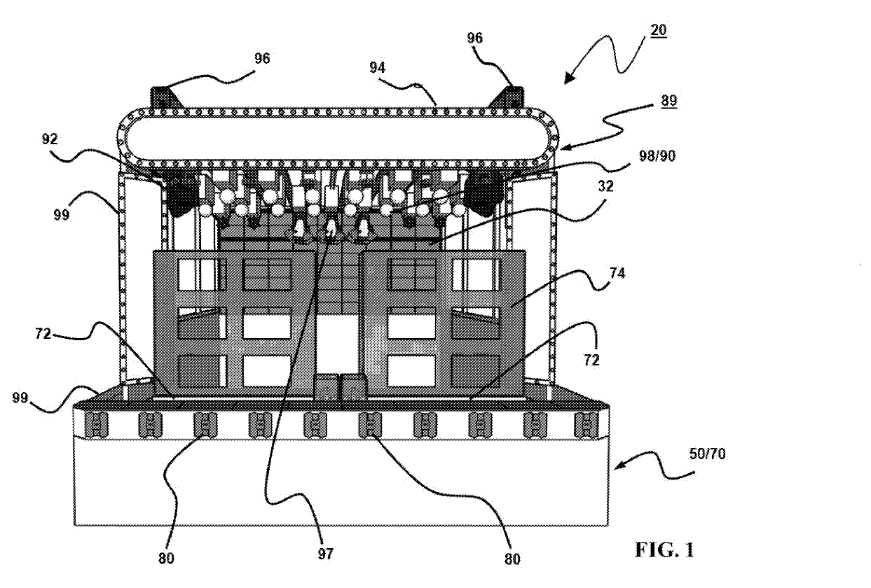

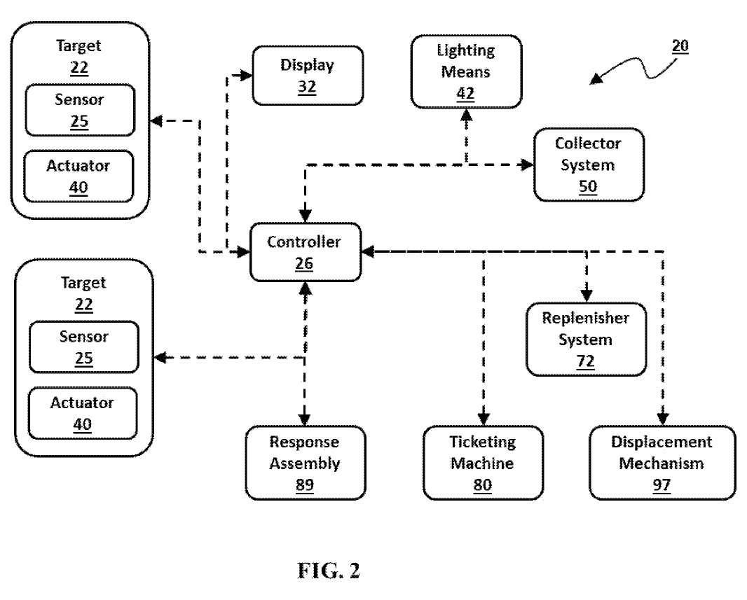

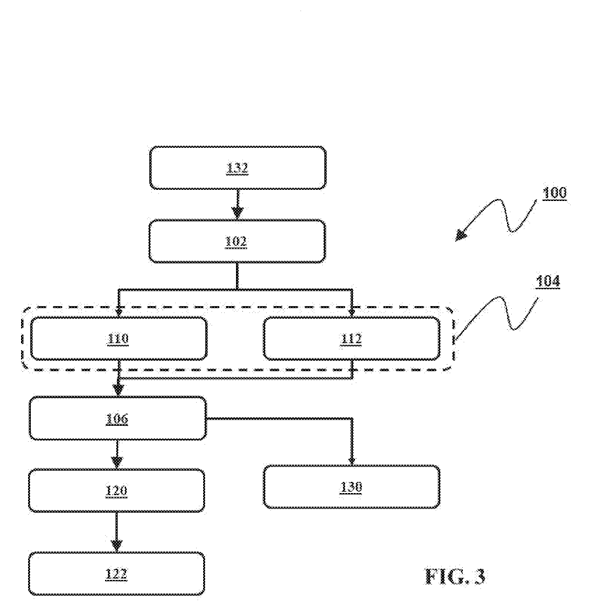

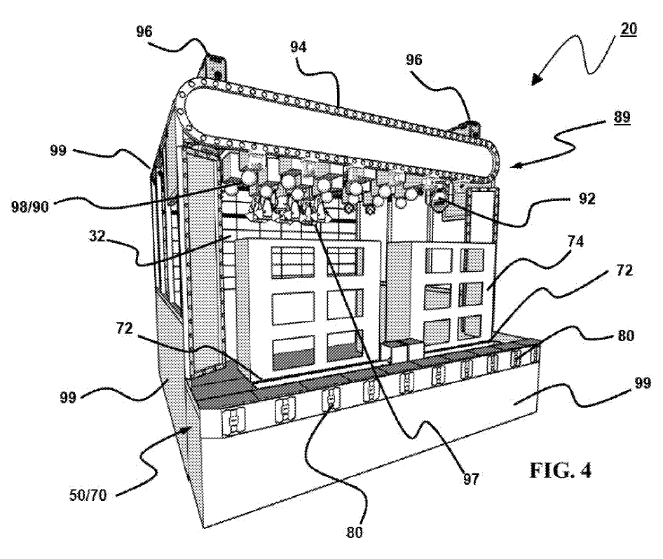

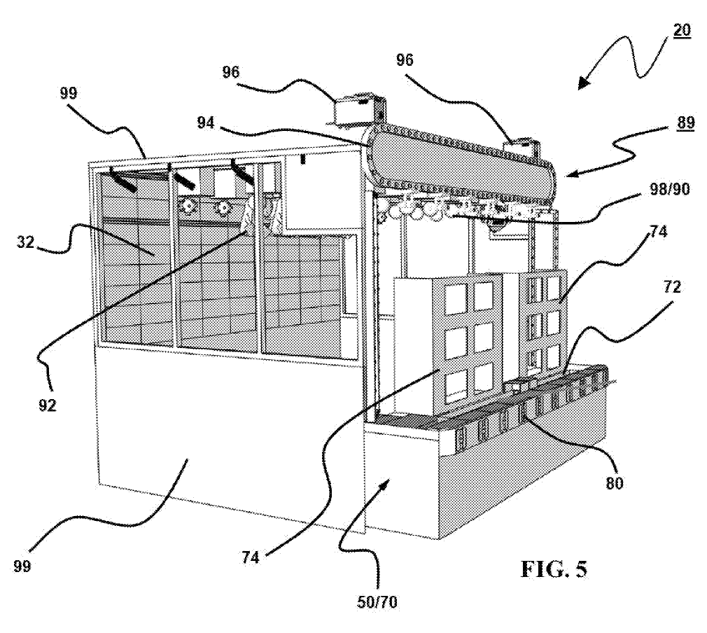

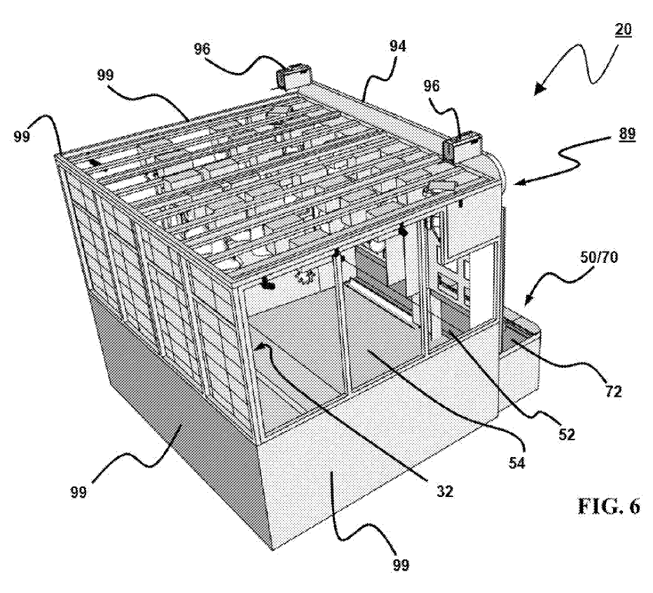

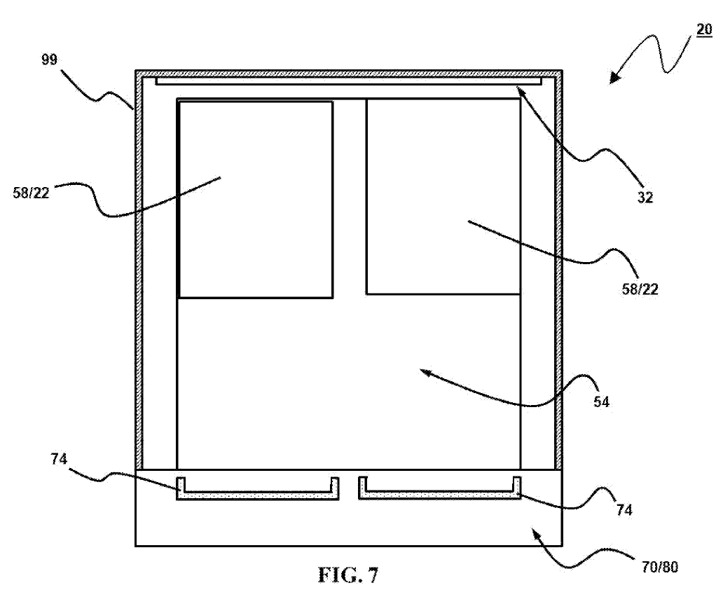

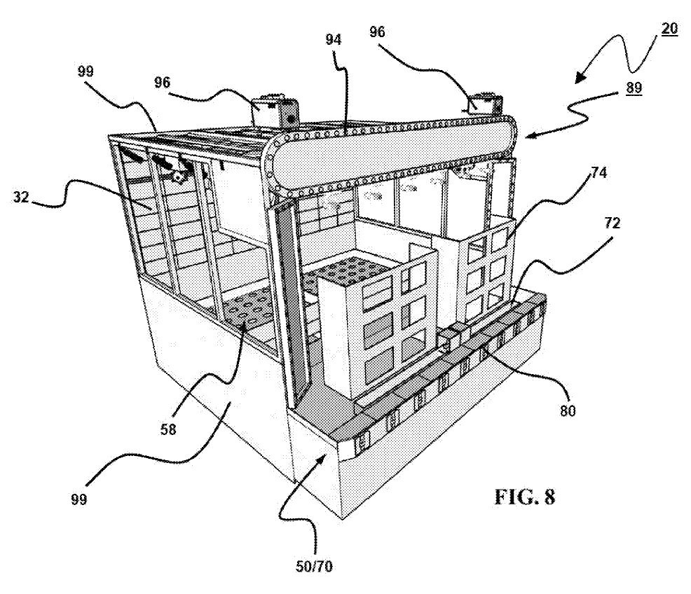

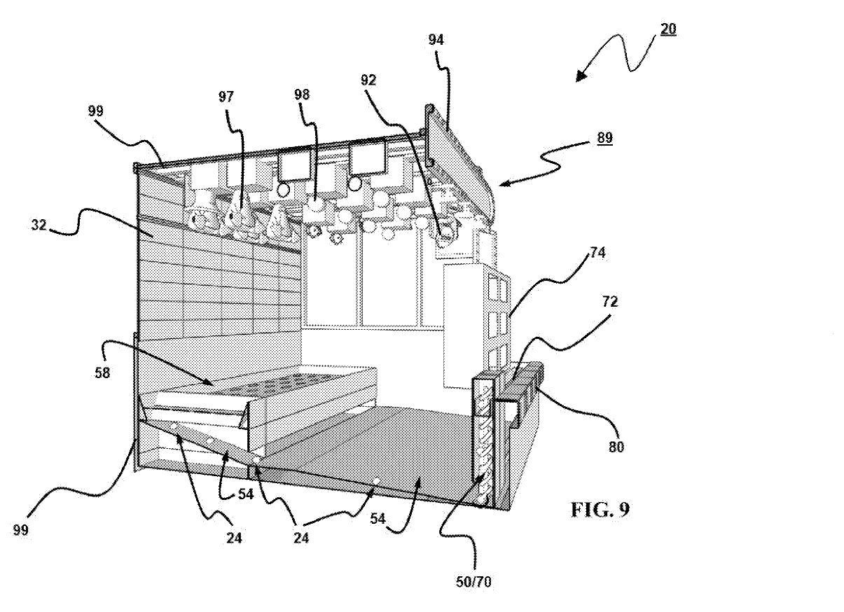

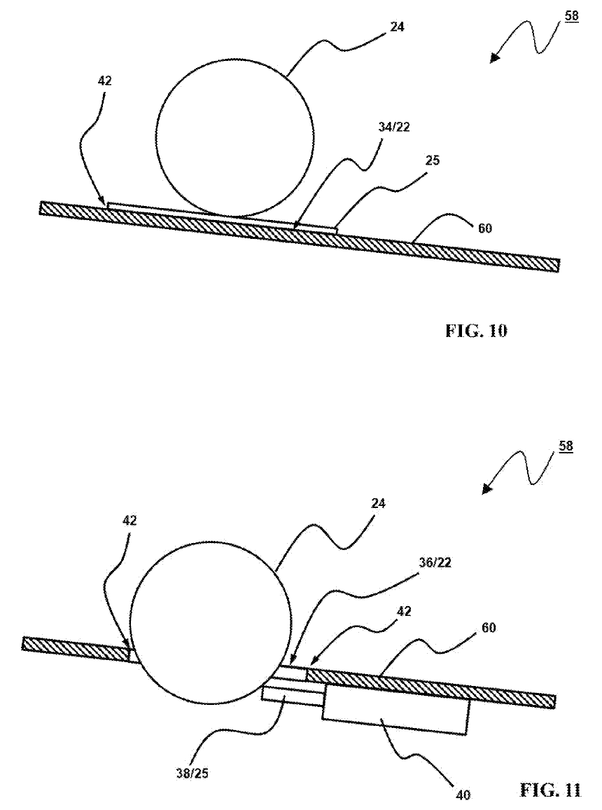

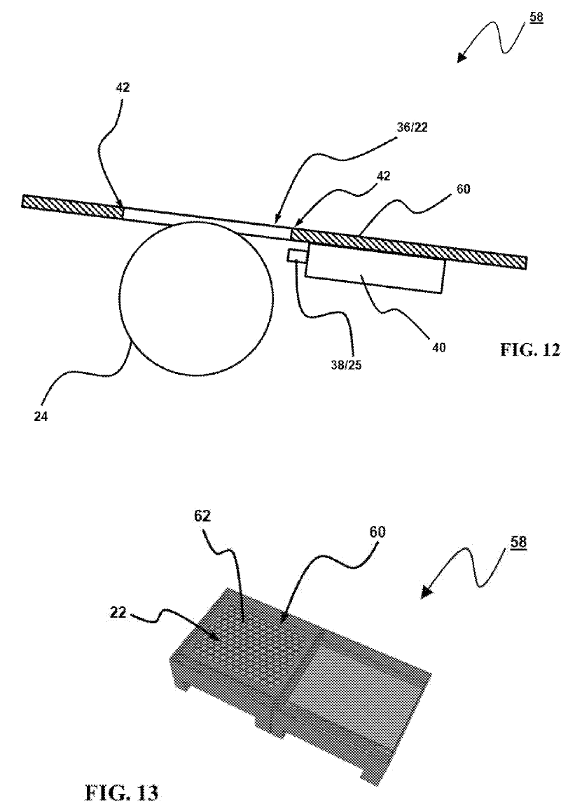

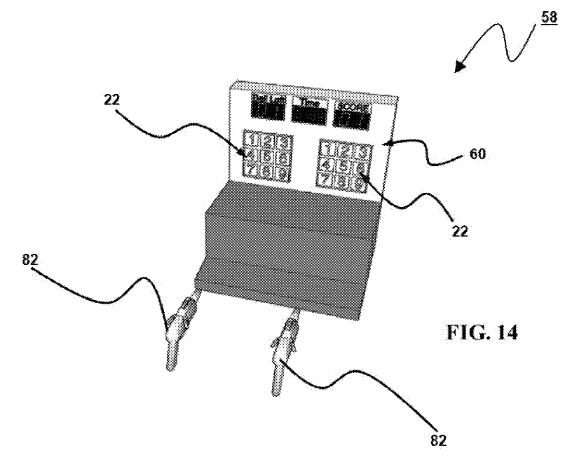

An exemplary embodiment of the present invention, a gaming system 20, is described hereinafter with reference to FIGS. 1 and 14. The gaming system 20 may be utilized and implemented using a gaming method 100. The gaming system 20 and the gaming method 100 may be provided in a carnival, an arcade or within a private premise for providing a plurality of games and game plays to various users.

The gaming system 20 comprises a plurality of targets 22 configured for being presented to a user for the launch of at least one object 24 thereto by a user. Each of the plurality of targets 22 has a sensor 25 for sensing interaction of the at least one object 24 therewith. The gaming system 20 further comprises a controller 26 wherewith the plurality of targets 22 are in signal communication. Each of the plurality of targets 22 has an identifier and a response associated with the identifier. The gaming system 20 further comprises a display 32 in signal communication with the controller 26 and for displaying at least one of generated graphics and video clip associated with the response associated with the identifier of the one of the plurality of targets 22 the object 24 launched by the user has interacted with. The at least one object 24 is preferably a ball, for example a rubber ball, a pickleball, a foam dart or the like projectiles.

The controller 26 can be a computing system, a micro-controller module, a programmable logic controller (PLC), a programmable integrated circuit (PIC) module or the like controller module with one or both of wired and wireless signaling means for communicating with and controlling sensors, devices, systems and components in signal communication therewith.

The display 32 is at least one of an LCD screen, an LED screen and a projector assembly comprising one or more projector and a projection surface or screen. The display 32 is further for displaying at least one of gaming instructions, type of prizes available, type of prize won, achievement and messages.

The controller 26 may be pre-programmed with a plurality of the identifiers and a plurality of the responses. Each of the plurality of the identifiers is uniquely associated with one of the plurality of targets 22. This will enable the controller 26 to identify which of the plurality of targets 22 the at least one object 24 has interacted with and to select and implement one of the response which corresponds with the target 22 which has been identified by the identifier. Some of the plurality of the response may correspond with certain combination of the plurality of targets 22 which has been interacted with or particular sequences or iterations of interactions with the plurality of targets 22.

In one implementation, each of the plurality of targets 22 defines a surface 34 with the sensor 25 thereof being one of integrated with and disposed adjacent thereto for sensing contact of the at least one object 24 therewith to register an interaction therewith. In another implementation, each of the plurality of targets 22 defines an aperture 36 being shaped and dimensioned for passage of at least a portion of the object 24 therethrough to register an interaction therewith. In such an implementation, the sensor 25 thereof is disposed adjacent the aperture 36 for sensing passage of at least a portion of the at least one object 24 therethrough.

In the implementation where each of the plurality of targets 22 defines the aperture 36, at least one of the plurality of targets 22 comprises a protrusion 38 movably coupled adjacent the aperture 36 thereof and displaceable between an extended position to occlude a portion of the aperture 36 for impeding passage of the object 24 therethrough, and a retracted position to enable passage of the object 24 through the aperture 36. Preferably, the protrusion 38 is resiliently biased. An example of a resiliently biased protrusion 38 is an elongated foam finger for cushioning the object 24 when it successfully enters the aperture 36 of one of the plurality of targets 22. The protrusion 38 may be configured to spatially displace from the aperture 36 and is shaped and dimensioned to enable the object 24 to sit within the aperture 36 and on the protrusion 38 without falling or rolling out of the aperture 36 when the protrusion 38 is in the extended position.

The at least one of the plurality of targets 22 further comprises an actuator 40 coupled to the protrusion 38 and in signal communication with the controller 26 for control thereby for actuating and positioning the protrusion 38 between the extended position and the retracted position. The sensor 25 of the at least one of the plurality of targets 22 is coupled with the protrusion for sensing interaction of the at least one object 24 with the protrusion 38 and consequently with the at least one of the plurality of targets 22 when the protrusion 38 is in the extended position. When in use, the protrusion 38 of each of the plurality of targets 22 are preferably in the extended position, by default. When the sensor 25 of the corresponding one of the targets 22 senses that the at least one object 24 has interacted therewith, the controller 26 will wait for elapse of a pre-defined duration before positioning the protrusion 38 to the retracted position to allow the object 24 to fall through and away from the aperture 36 before returning the protrusion 38 back to the extended position.

Preferably, at least one of the plurality of targets 22 comprising lighting means 42 for illuminating at least a portion of the at least one of the plurality of targets 22. Examples of the lighting means 42 comprises an LED strip and a light guide which surround the periphery of the opening of the aperture 36.

The gaming system 20 further comprises a collector system 50 configured with the plurality of targets 22 and positioned for receiving the at least one object 24 that has been launched towards the plurality of targets 22 by the user, the collector system 50 being shaped and dimensioned for gravitationally conveying the received at least one object 24 towards a collection point 52.

The collector system 50 comprising at least one of a funnel and an inclined ramp 54 for at least one of funneling and gravitationally guiding the at least one object 24 from the plurality of targets 22 to the collection point 52.

The gaming system 20 further comprises a target module 58 comprising a structure 60, for example a panel structure, having a plurality of marks. The plurality of marks can be a plurality of pre-defined visual markings or prints on the structure 60, shaped objects such as baskets and ball hoops, or a plurality of openings 62. Preferably, the plurality of openings 62 are shaped and dimensioned for passage of the at least one object 24 therethrough. At least one of the plurality of openings 62 is one of the plurality of targets 22. The structure 60 is configured with the collector system 50 to enable the at least one object 24 passaging through each of the plurality of openings 62 to be received by the collector system 50. For example, the structure 60 is a planar Perspex panel with the plurality of the openings 62 formed therein. As not all of the plurality of openings 62 are the plurality of targets 22 in some gameplays, the plurality of targets 22 may be marked, for example using visual markings or different coloured markings from those of the other openings 62. Colour differentiated marking may also be used to mark the plurality of targets 22 to differentiate between game or achievement values between the plurality of targets 22. The structure 60 may be positioned horizontally, vertically or slanted based on game and gameplay. Further, various target modules 58 are available for different games and gameplays with varying arrangements and configurations of the plurality of targets 22 allowing interchange between the various target modules 58 for a particular gaming system 20. More than one of the target modules 58 may be deployed in the gaming system 20 at any one time.

The target module 58, together with the plurality of marks, may be configured to present a variety of games and game plays including but not limited to goblet toss, street nineballs, basket toss, milk jug toss, can blaster, mini basketball and shoot the duck games.

The gaming system 20 further comprises a user station 70 which physically indicates one of an area and a location wherefrom the user is to launch the at least one object 24 towards the plurality of targets 22 and whereat the at least one object 24 is presentable to the user. The gaming system 20 further comprises a replenisher system 72 for collecting from the collection point 52 and presenting a predefined quantity of the at least one objects 24 to the user at the user station 70.

The gaming system 20 preferably comprises a divider structure 74 disposed at the user station 70 and substantially interposing the user and the plurality of targets 22 for substantially impeding reach of the user towards the plurality of targets 22 when launching the at least one object 24, the divider structure 74 defining a plurality of openings 62.

The gaming system 20 also comprises a ticketing machine 80 disposed one of at and adjacent the user station 70 for dispensing one or more tickets based on the response associated with the identifier of the one of the plurality of targets 22 the launched at least one object 24 has successfully interacted with.

The gaming system 20 further comprises a launch apparatus 82 adapted for assisting launch of the at least one object 24 by one of rolling and projecting the at least one object 24 towards the plurality of targets 22. One example of the launch apparatus 82 comprises an elongated hollow tube that has been pivotably mounted on a stand so that the object 24 may be rolled therethrough towards the plurality of targets 22 once the user poses the hollow tube in the desired orientation. Another example of the launch apparatus 82 comprises a pneumatically-assisted launcher for launching the at least one object 24 towards the plurality of targets 22.

The gaming system 20 further comprises a response assembly 89 comprising at least one of a speaker assembly 90 being activatable for delivering a predefined audio clip, a light projector 92 being activatable for projecting and controlling the direction and sequence of light beams, a lighting assembly 94 being activatable for the delivery of lighting effects, a smoke machine 96 being activatable for generating a burst of smoke or atomized mist, and at least one bell 98 coupled with an actuator 40 being activatable for ringing the plurality of bells. The response assembly 89 can further comprise one or more displacement mechanism 97 being activatable for providing the response. For example, the one or more automated mechanism is one or more claws being suspended from an actuator or a winch and controllable for positioning and reciprocating between a lowered position and a raised position. The one or more claws may have objects, for example soft toys, coupled thereto for attracting the attention of users when being lowered and raised by the one or more claws.

The at least one of the speaker assembly 90, the light projector 92, the lighting assembly 94, the smoke machine 96 and the at least one bell 98 coupled to the actuator 40 being in signal communication with the controller 26 for controlled activation thereby based on the response associated with the identifier of the one of the plurality of targets 22 the object 24 launch by the user has interacted with.

It is preferred that the gaming system 20 comprises a support structure 99 for supporting and housing the various elements of the gaming system that have been aforementioned. The support structure 99 can be a collapsible cage structure, a truss structure or a rectilinear metal frame that allows easy assembly and disassembly while allowing the various above elements of the gaming system 20 to be configured with the support structure 99.

The gaming method 100 comprises presenting the plurality of targets 22 to a user for the launch of at least one object 24 thereto by the user in a step 102, sensing interaction of the at least one object 24 with one of the plurality of targets 22 in a step 104, and displaying on a display 32 at least one of generated graphics and video clip associated with the response associated with the identifier of the one of the plurality of targets 22 the object 24 launched by the user has interacted with in a step 106.

In the implementation where each of the plurality of targets 22 defines the aperture 36, the controller 26 will wait for elapse of a pre-defined duration before positioning the protrusion 38 to the retracted position, in a step 110, to allow the object 24 to fall through and away from the aperture 36 when the sensor 25 of the corresponding one of the targets 22 senses that the at least one object 24 has interacted therewith and before returning the protrusion 38 back to the extended position in a step 112.

Next, in a step 120, the response assembly 89 may be activated by the controller to at least one of deliver a predefined audio clip by the speaker assembly 90, initiate projecting and directing and sequencing of light beams by the light projector 92 based on a pre-defined program; delivering of lighting effects by the lighting assembly 94; generating a burst of smoke or atomized mist by the smoke machine 96; and initiate ringing at least one bell 98 for a pre-defined duration and at a pre-defined tempo. The ticketing machine 80 may then dispense one or more tickets in a step 122 based on the response associated with the identifier of the one of the plurality of targets 22 the launched at least one object 24 has successfully interacted with.

Further, the at least one object 24 that has been launched towards the plurality of targets 22 is received by the collector system 50 and at least one of funneled and gravitationally guided to the collection point 52 in a step 130.

Based on payment made by the user at the user station 70 using either hard currencies, wireless payment, card readers or ticket readers, a predefined quantity of the at least one objects 24 may be collected from the collection point 52 and presented to the user at a user station 70 by the replenisher system 72 in a step 132.

Aspects of particular embodiments of the present disclosure address at least one aspect, problem, limitation, and/or disadvantage associated with existing gaming systems and method. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. A gaming system comprising:
a plurality of targets configured for being presented to a user for the launch of at least one object thereto by the user, each of the plurality of targets having a sensor for sensing interaction of the at least one object therewith;
a controller wherewith the plurality of targets are in signal communication, each of the plurality of targets having an identifier and a response associated with the identifier; and
a display in signal communication with the controller and for displaying at least one of generated graphics and video clip associated with the response associated with the identifier of the one of the plurality of targets the object launched by the user has interacted with.

2. The gaming system as in claim 2 each of the plurality of targets defining a surface with the sensor thereof being one of integrated with and disposed adjacent thereto for sensing contact of the at least one object therewith.

3. The gaming system as in claim 2, each of the plurality of targets defining an aperture being shaped and dimensioned for passage of at least a portion of the object therethrough, the sensor thereof being disposed adjacent the aperture for sensing passage of at least a portion of the at least one object therethrough.

4. The gaming system as in claim 3, at least one of the plurality of targets comprising:
a protrusion movably coupled adjacent the aperture thereof and displaceable between an extended position to occlude a portion of the aperture for impeding passage of the object therethrough and a retracted position to enable passage of the object through the aperture; and
an actuator coupled to the protrusion and in signal communication with the controller for control thereby for actuating the protrusion between the extended position and the retracted position,
wherein the sensor of the at least one of the plurality of targets is coupled with the protrusion for sensing interaction of the at least one object with the protrusion and consequently with the at least one of the plurality of targets when the protrusion is in the extended position.

5. The gaming system as in claim 1, at least one of the plurality of targets comprising lighting means for illuminating at least a portion of the at least one of the plurality of targets.

6. The gaming system as in claim 1, the display being at least one of an LCD screen, an LED screen and a projector assembly.

7. The gaming system as in claim 1, further comprising:
a collector system configured with the plurality of targets and positioned for receiving the at least one object that has been launched towards the plurality of targets by the user, the collector system being shaped and dimensioned for gravitationally conveying the received at least one object towards a collection point.

8. The gaming system as in claim 7, the collector system comprising at least one of a funnel and an inclined ramp for at least one of funneling and gravitationally guiding the at least one object from the plurality of targets to the collection point.

9. The gaming system as in claim 7, further comprising:
a panel structure having a plurality of openings being shaped and dimensioned for passage of the at least one object therethrough, at least one of the plurality of openings being one of the plurality of targets, the panel structure being configured with the collector system to enable the at least one object passaging through each of the plurality of openings to be received by the collector system.

10. The gaming system as in claim 7, further comprising:
a user station which physically indicates one of an area and a location wherefrom the user is to launch the at least one object towards the plurality of targets and whereat the at least one object is presentable to the user.

11. The gaming system as in claim 10, further comprising:
a replenisher system for collecting from the collection point and presenting a predefined quantity of the at least one objects to the user at the user station.

12. The gaming system as in claim 10, further comprising:
a divider structure disposed at the user station and substantially interposing the user and the plurality of targets for substantially impeding reach of the user towards the plurality of targets when launching the at least one object, the divider structure defining a plurality of openings.

13. The gaming system as in claim 10, further comprising:
a ticketing machine disposed one of at and adjacent the user station for dispensing one or more tickets based on the response associated with the identifier of the one of the plurality of targets the launched at least one object has successfully interacted with.

14. The gaming system as in claim 10, further comprising:
a launch apparatus adapted for assisting launch of the at least one object by one of rolling and projecting the at least one object towards the plurality of targets.

15. The gaming system as in claim 1, further comprising at least one of:
a speaker assembly being activatable for delivering a predefined audio clip;
a light projector being activatable for projecting and controlling the direction and sequence of light beams;
a lighting assembly being activatable for the delivery of lighting effects;
a smoke machine being activatable for generating a burst of smoke or atomized mist; and
at least one bell coupled with an actuator being activatable for ringing the plurality of bells,
wherein the at least one of the speaker assembly, the light projector, the lighting assembly, the smoke machine and the at least one bell coupled to the actuator being in signal communication with the controller for controlled activation thereby based on the response associated with the identifier of the one of the plurality of targets the object launch by the user has interacted with.

16. The gaming system as in claim 1, the display further for displaying at least one of gaming instructions, type of prizes available, type of prize won, achievement and messages.

17. A gaming method comprising:
presenting a plurality of targets to a user for the launch of at least one object thereto by the user, the plurality of targets are in signal communication with a controller, each of the plurality of targets having a sensor, an identifier and a response associated with the identifier;
sensing interaction of the at least one object with one of the plurality of targets; and
displaying on a display at least one of generated graphics and video clip associated with the response associated with the identifier of the one of the plurality of targets the object launched by the user has interacted with, the display in signal communication with the controller,
wherein the display further for displaying at least one of gaming instructions, type of prizes available, type of prize won, achievement and messages.

18. The gaming method as in claim 17, at least one of the plurality of targets comprising lighting means for illuminating at least a portion of the at least one of the plurality of targets, and the display being at least one of an LCD screen, an LED screen and a projector assembly.

19. The gaming method as in claim 17, further comprising:
receiving the at least one object that has been launched towards the plurality of targets by a collector system, the collector system being shaped and dimensioned for gravitationally conveying the received at least one object towards a collection point, the collector system comprising at least one of a funnel and an inclined ramp for at least one of funneling and gravitationally guiding the at least one object from the plurality of targets to the collection point; and
collecting from the collection point and presenting a predefined quantity of the at least one objects to the user at a user station by a replenisher system, the user station physically indicates one of an area and a location wherefrom the user is to launch the at least one object towards the plurality of targets and whereat the at least one object is presentable to the user.

20. The gaming method as in claim 17, further comprising at least one of:
delivering a predefined audio clip by a speaker assembly;
projecting and controlling the direction and sequence of light beams by a light projector;
delivering of lighting effects by a lighting assembly;
generating a burst of smoke or atomized mist by a smoke machine; and
ringing at least one bell,
wherein the at least one of the speaker assembly, the light projector, the lighting assembly, the smoke machine and the at least one bell coupled for actuation by an actuator being in signal communication with the controller for controlled activation thereby based on the response associated with the identifier of the one of the plurality of targets the object launch by the user has interacted with.
